(19) United States
(12) Patent Application Publication
(10) Pub. No.: US 2014/0272577 A1
(43) Pub. Date: Sep. 18, 2014

(54) METHODS AND APPARATUS FOR HIGH CAPACITY ANODES FOR LITHIUM BATTERIES

(71) Applicant: SANDISK 3D LLC, Milpitas, CA (US)

(72) Inventors: Renee Hartner, San Jose, CA (US); Yitzhak Gilboa, San Jose, CA (US); Priyanka Kamat, Palo Alto, CA (US); Kang-Jay Hsia, Pleasanton, CA (US)

(73) Assignee: SanDisk 3D LLC, Milpitas, CA (US)

(21) Appl. No.: 13/828,301

(22) Filed: Mar. 14, 2013

(51) Int. Cl. H01M 4/134; H01M 4/04

(52) U.S. Cl. CPC H01M 4/134; H01M 4/04
USPC 429/218.1; 29/623.1

(57) ABSTRACT

An electrode is provided for an electrochemical lithium battery cell. The electrode includes multiple silicon sheets, each silicon sheet including multiple apertures, each aperture extending all or partly through a thickness of the silicon sheet. Numerous other aspects are provided.

### BACKGROUND

This invention relates to electrodes for batteries. More particularly, this invention relates to methods and apparatus for high capacity anodes for lithium batteries.

### SUMMARY

In a first aspect of the invention, an electrode is provided for an electrochemical lithium battery cell. The electrode includes a bulk material that has a plurality of voids dispersed substantially throughout the bulk material. The bulk material is silicon.

In a second aspect of the invention, a method is provided for forming an electrode for an electrochemical lithium battery cell. The method includes providing hollow silicon spheres, providing silicon nanodots, mixing the silicon spheres and the silicon nanodots to form a composite mixture, molding the composite mixture to a predetermined shape, heating the molded composite mixture to melt the silicon nanodots without melting the silicon spheres, and cooling the molded composite mixture to cure the melted silicon.

In a third aspect of the invention, an electrode is provided for an electrochemical lithium battery cell. The electrode includes multiple silicon sheets, each silicon sheet including multiple apertures, each aperture extending all or partly through a thickness of the silicon sheet.

In a fourth aspect of the invention, a method is provided for providing an electrode for an electrochemical lithium battery cell. The method includes providing multiple silicon sheets, and forming multiple apertures in the silicon sheets, each aperture extending all or partly through a thickness of the silicon sheet.

Other features and aspects of this invention will become more fully apparent from the following detailed description, the appended claims and the accompanying drawings.

### BRIEF DESCRIPTION OF THE DRAWINGS

Features of the present invention can be more clearly understood from the following detailed description considered in conjunction with the following drawings, in which the same reference numerals denote the same elements throughout, and in which:

FIGS. 1A-1D illustrate various views of an example anode in accordance with this invention;

FIG. 2 illustrates a cross-sectional view of an example device for forming an anode in accordance with this invention;

FIG. 3 illustrates a cross-sectional view of an anode formed using the device of FIG. 2;

FIGS. 4A-4C illustrate cross-sectional views of the anode of FIG. 3 during a charging process;

FIGS. 5A-5C illustrate an example silicon sheet in accordance with this invention;

FIGS. 6A-6D illustrate various views of example silicon anode elements in accordance with this invention including stacks of the silicon sheets of FIGS. 5A-5C;

FIGS. 7A-7B illustrate views of the silicon anode element of FIG. 6A during a charging process;

FIG. 8 illustrates an example battery cell container that may be used with silicon anode elements in accordance with this invention;

FIG. 9A-9F illustrate various views of an example anode element container in accordance with this invention; and

FIG. 10 illustrates a cross-sectional view of an example battery cell in accordance with this invention.

### DETAILED DESCRIPTION

Lithium ion batteries are currently used in a wide variety of applications, including portable electronics, such as laptop computer, tablet computers and cell phones, and transportation devices, such as electric vehicles and commercial aircraft. Indeed, lithium ion batteries have the highest specific energy and energy density among chemical and electrochemical energy storage systems.

A lithium ion battery typically includes a negative electrode (referred to herein as an “anode”), a positive electrode (referred to herein as a “cathode”), and an electrolyte layer between the anode and cathode. In particular, lithium ion batteries typically include an anode made from carbon, a cathode made from a metal oxide, and an electrolyte that includes a lithium salt in an organic solvent. The electrical storage capacity of a lithium ion battery is limited by how much lithium can be held in the anode. Silicon has a much higher capacity than carbon. Thus a lithium ion battery that includes a silicon anode may have higher storage capacity than convention carbon-anode batteries used today.

Unfortunately, a silicon anode expands as it absorbs positively charged lithium atoms during charging, and then contracts during discharging as the lithium is drawn out of the silicon. This expansion/contraction cycle typically causes the silicon (often in the form of particles or a thin film) to pulverize, degrading the performance of the battery.

In addition, following a number of charging and discharging cycles, a portion of a silicon anode may exhibit reduced charging capabilities or otherwise become defective, and yet the remainder of the silicon anode functions normally. For example, when silicon anodes are lithiated, they form a solid-electrolyte interphase (“SEI”) at their surface. The SEI is formed from solvent and electrolytic salt that is electrochemically reduced to oligomers and inorganic crystals on the silicon surfaces. The SEI acts as a barrier between the electrolyte solution and the anode, and reduces the storage capacity of the battery. Thus, although the SEI forms on a single surface of a silicon anode, the entire silicon anode must be removed and replaced, which increases cost and waste.

Apparatus and methods in accordance with this invention seek to overcome these problems associated with silicon anodes. In particular, in some embodiments, apparatus and methods in accordance with this invention include or provide silicon anodes that have a porous structure that may allow the silicon anode to expand and contract during charging and discharging.

In addition, in some embodiments, apparatus and methods in accordance with this invention include or provide silicon anodes made of multiple silicon anode elements. If a SEI forms on one of the silicon anode elements (or one of the silicon anode elements is otherwise defective), the silicon element may be removed and replaced without having to replace the entire silicon anode.

Referring to FIGS. 1A-1D, an example anode 10 in accordance with this invention. Anode 10 includes a bulk material 12 having apertures or voids 14 dispersed substantially throughout bulk material 12. Bulk material 12 may be silicon (“Si”), aluminum (“Al”), germanium (“Ge”), tin (“Sn”), lead (“Pb”), antimony (“Sb”), magnesium (“Mg”), copper (“Cu”), nickel (“Ni”), or alloys or mixtures thereof, silicon alloys with elements such as Sn, Ni, Cu, Ge, iron (“Fe”), cobalt (“Co”), manganese (“Mn”), zinc (“Zn”), indium (“In”), silver (“Ag”), titanium (“Ti”), bismuth (“Bi”), antimony (“Sb”), and chromium (“Cr”), silicon oxides and carbides, alloys such as Cu—Sn, Sb—Sn, and metal oxides such as SnO₂. Other anode materials also may be used for bulk material 12.

For simplicity, the remaining discussion will describe anodes 10 that include bulk material 12 made of silicon (referred to herein as “silicon 12”). Persons of ordinary skill in the art will understand, however, that the example embodiments describe also may be made of other anode materials, such as the materials described above.

Anode 10 may have a length between about 2 cm and about 30 cm, a width between about 2 cm and about 30 cm, and a thickness between about 10 mm and about 10 cm, although other dimensions may be used. In addition, although anode 10 is depicted as a rectangular prism, anodes in accordance with this invention may have other shapes, such as triangular prisms, hexagonal prisms, polyhedrons, cylinders, cones, spheres and other suitable shapes.

Voids 14 may have a diameter between about 10 nm and about 10 mm. In addition, although voids 14 are depicted as having spherical shapes, voids 14 may have other shapes, such as rectangular, triangular, hexagonal, polyhedral, cylindrical, conical, and other suitable shapes, having any of a variety of different shapes. Persons of ordinary skill in the art will understand that voids 14 may include a variety of different shapes and sizes, and that other dimensions may be used.

In accordance with this invention, anode 10 is enclosed in a rigid container (not shown in FIGS. 1A-1D) that substantially prevents silicon 12 from peripheral expansion during charging in a lithium ion battery cell. Instead, in accordance with this invention, the volume expansion and contraction that occurs in silicon 12 during charging and discharging is substantially confined to voids 14.

For example, FIG. 1C illustrates a perspective view of anode 10 in a discharged state in which lithium is not inserted into silicon 12. As anode 10 is charged, lithium ions penetrate silicon 12, which causes silicon 12 to swell. However, because anode 10 is enclosed in a rigid container, silicon 12 is substantially prevented from expanding outwardly. Instead, as shown in FIG. 1D, as lithium is inserted into silicon 12, voids 14 are compressed, and the volume expansion of silicon 12 occurs substantially in the volume originally occupied by voids 14. Further, as anode 10 discharges, lithium is extracted from silicon 12, which causes silicon 12 to shrink. As lithium is extracted from silicon 12, voids 14 expand to their original volume, as depicted in FIG. 1C.

Anodes 10 in accordance with this invention may be fabricated using a variety of different techniques. In a first example technique, hollow silicon spheres and silicon nanodots are mixed together to form a composite mixture, the resulting composite mixture is molded to a predetermined shape, the molded composite mixture is heated to melt the silicon nanodots without melting the silicon spheres, the molded composite mixture is allowed to cool to cure the melted silicon to form a silicon anode.

FIG. 2 illustrates a cross-sectional view of a mold 20 having sidewalls 22. Mold 20 is substantially filled with silicon spheres 24, silicon nanodots 26 and voids 28 disposed between adjacent silicon spheres 24 and silicon nanodots 26. Mold 20 may have a rectangular shape, although other shapes such as square, cylindrical, or other suitable shapes may be used.

In an example embodiment, mold 20 may have a rectangular shape having a length between about 10 cm and about 20 cm, a width between about 10 cm and about 20 cm, and a height between between about 1 cm and about 2 cm. Other lengths, widths and heights may be used. Mold 20 may be made of metal, plastic, ceramic, glass, or other suitable material.

Silicon spheres 24 have a hollow center 14a and sidewalls 30. Silicon spheres 24 may have a diameter between about 600 nm and about 10 mm, preferably between about 5 mm and about 10 mm. Other diameters may be used. Sidewalls 30 have a thickness/diameter ratio (i.e., the ratio of the thickness of sidewalls 30 to the diameter of silicon sphere 24) between about 1/10 and about ⅕, preferably between about ⅙ and about ⅕. Other thickness/diameter ratios may be used.

Silicon spheres 24 in mold 20 all may have the same dimensions, or may have a variety of different dimensions, such as depicted in FIG. 2. Silicon spheres 24 may have spherical, elliptical, rectangular or other suitable shapes. Silicon spheres 24 in mold 20 all may have the same shapes, such as depicted in FIG. 2, or may have a variety of different shapes.

Silicon spheres 24 may be fabricated using a technique similar to that described in “Hollow Spheres Made Of Metal,” Science Daily, Oct. 13, 2009 (published at http://www.sciencedaily.com/releases/2009/10/091012095709. htm) (referred to herein as “the IFAM Report”), which is incorporated by reference herein in its entirety for all purposes. The IFAM Report explains that researchers at the Fraunhofer Institute for Manufacturing and Advanced Materials (“IFAM”) have developed a method to create solid method spheres using polystyrene balls and metal.

In particular, the IFAM Report states that the process starts with polystyrene balls which are lifted up and held by an air current over a fluidized bed while a suspension consisting of metal powder and binder is sprayed onto them. When the metal layer on the balls is thick enough, heat treatment begins, in which all the organic components, the polystyrene and the binder evaporate. The residual materials are gaseous and escape through the pores in the metal layer. A fragile ball of metal remains. This is sintered at just below melting temperature, and the metal powder granules bind together, forming a hard and cohesive shell.

Silicon spheres 24 may be created by using a similar technique to that described in the IFAM Report, by using silicon in place of metal, and using an inert gas (e.g., helium, neon, argon, krypton, xenon, radon, purified nitrogen, purified argon, or other suitable inert gas) instead of an organic component like the polystyrene balls. The result produces silicon spheres 24 that include a hollow center 14a filled with inert gas. Persons of ordinary skill in the art will understand that other suitable techniques may be used to form silicon spheres 24.

Silicon nanodots 26 may have a diameter between about 20 nm and about 100 nm, preferably between about 20 nm and about 50 nm, although other diameters may be used. Silicon nanodots 26 may be fabricated using techniques such as described in Park et al. U.S. Pat. No. 8,115,189 and Park et al. U.S. Pat. No. 7,985,666, or other suitable method.

Silicon nanodots 26 all may have the same dimensions, or may have a variety of different dimensions, such as depicted in FIG. 2. Silicon nanodots 26 may have spherical, elliptical rectangular or other suitable shapes. Silicon nanodots 26 all may have the same shapes, such as depicted in FIG. 2, or may have a variety of different shapes.

Silicon spheres 24 and silicon nanodots 26 are mixed together to form a composite mixture, and the composite mixture may then be deposited into mold 20. In particular, silicon spheres 24 and silicon nanodots 26 may be mixed in a solid state or in a liquid solution, with or without a polymer matrix. Examples of each of these techniques will be discussed in turn.

In an example solid state method, a ratio of about 90-40% silicon spheres 24 to about 10-60% silicon nanodots 26 is selected. Binders such as PVDF, acrylic and other polymeric, or cellulosic binders may be added in weight ratios of about 0-20%. Additionally, or alternatively, adhesion promoters such as silanes, silicones, or other commercial adhesion promoters may be added in weight ratios of about 0-20%.

For example, a composite may be made using 40 wt % silicon spheres 24, 40 wt % silicon nanodots 26, 10 wt % binder and 10 wt % adhesion promoter. Other weight ratios may be used. The resulting composite may be mixed using any convention mixing method, such as blending, ball milling, conical screw mixing or any solid powder mixing. A block of this mixture can then be pressed or pelleted out into desired shapes.

In an example liquid solution method, silicon spheres 24, silicon nanodots 26, binders and/or adhesion promoters are selected in desired weight ratios, such as described above, and are dispersed in such solvent, such as water, an alcohol, a ketone, a hydrocarbon or other organic solvent. Preferably, a solvent having a high vapor pressure or low boiling point may be used, such as hexane, dichloromethane, chloroform, toluene, xylene, diethyl ether, acetone, acetonitrile, isopropanol, ethanol, methanol, or other suitable solvent.

For example, a solvent may be added to 40 wt % silicon spheres 24, 40 wt % silicon nanodots 26, 10 wt % binder and 10 wt % adhesion promoter. Other weight ratios may be used. A particle dispersion or a slurry may be made using any conventional technique, such as sonication, mechanical mixing, shear mixing, or other suitable technique.

In an example polymer matrix method, silicon spheres 24, silicon nanodots 26 and additives may be deposited in a polymeric matrix, such as acrylates, polyethylene, polypropylene, epoxy, silicones, phenolic, polyester, polyimide, polyurethanes, or other similar polymeric matrix. For example, between about 10-50 wt % polymeric additive may be mixed with silicon spheres 24 and silicon nanodots 26. In case of monomer addition, crosslinkers, and chemical initiators may be added for polymerization. These components are then thoroughly mixed as with the liquid solution method described above. Persons of ordinary skill in the art will understand that other techniques may be used form a composite mixture of silicon spheres 24 and silicon nanodots 26.

The composite mixture of silicon spheres 24 and silicon nanodots 26 may then be deposited to substantially fill mold 20. An inert gas (e.g., helium, neon, argon, krypton, xenon, radon, purified nitrogen, purified argon, or other suitable inert gas) may be injected into mold 20 to fill voids 28, and mold 20 may then be substantially sealed. The injected gas may be filled to a pressure between about 1 Pa and about 2 Pa, although other pressures may be used.

Mold 20 may then be heated at a temperature between about 1200° C. and about 1400° C., for about 1 minute to about 10 minutes. Other temperatures and/or times may be used. Heating may be performed by baking, laser heating, rapid thermal processing, or other suitable technique.

As is known in the art, melting point depression is a phenomenon of reduction of the melting point of a material with reduction of its size. Melting point depression is very prominent in nanoscale materials, which may melt at temperatures hundreds of degrees lower than that of corresponding bulk materials.

Thus, in a composite mixture of silicon spheres 24 and silicon nanodots 26 such as in the dimensions described above, silicon nanodots 26 melt at a temperature below that of silicon spheres 24. Thus, by heating mold 20 to a temperature near but below the melting point of silicon (such as the temperatures described above), silicon nanodots 26 will melt, but silicon spheres 24 remain solid. As a result, silicon nanodots 26 melt to form a pool of liquid silicon that substantially surrounds silicon spheres 24. Following heat treatment, the liquid silicon solidifies, and silicon spheres 24 become embedded in the solid silicon.

FIG. 3 illustrates an example anode 10a formed using this process with mold 20 of FIG. 2. In particular, anode 10a includes silicon 12a formed by melting silicon nanodots 26, and then allowing the molten silicon to cool and solidify. Silicon spheres 24 become embedded in silicon 12a and are substantially immobile.

Sidewalls 22 of mold 20 may thus form a rigid container that encases anode 10a and substantially prevents silicon 12a from peripheral expansion during charging in a lithium ion battery cell. In accordance with this invention, the volume expansion and contraction that occurs in silicon 12a during charging and discharging of anode 10a is substantially confined to hollow centers 14a of silicon spheres 24.

As anode 10a is charged, lithium ions penetrate silicon 12a, which causes silicon 12a to swell. However, because anode 10a is enclosed in sidewalls 22, silicon 12a is substantially prevented from expanding outwardly. Instead, as lithium is inserted into silicon 12a, sidewalls 30 of silicon spheres 24 expand, hollow centers 14a are compressed, and the volume expansion of silicon 12a occurs substantially in the volume originally occupied by hollow centers 14a, as shown in FIGS. 4A-4C. Further, as anode 10a discharges, lithium is extracted from silicon 12a, sidewalls 30 of silicon spheres 24 contract, and hollow centers 14a expand to their original volume, returning to the structure shown in FIG. 3.

As described above, anodes 10 in accordance with this invention may be fabricated using a variety of different techniques. In a second example technique, apertures are formed in thin silicon sheets, and multiple silicon sheets are stacked to form a silicon anode element. The holes may extend all or partly through a thickness of the silicon sheets. Multiple silicon anode elements may be combined to form a silicon anode. If any of the silicon anode elements becomes defective, the defective silicon anode element may be removed and replaced, without needing to replace the entire silicon anode.

Referring now to FIGS. 5A-5C, and example silicon sheet 40 in accordance with this invention is described. Silicon sheet 40 includes silicon substrate 12b having first apertures 14b, and optionally including second apertures 42. First apertures 14b may have a circular shape, such as shown in FIGS. 5A-5C, or may have rectangular, elliptical, triangular, or other suitable shape. First apertures 14b may extend all or partly through a thickness of silicon sheet 14.

First apertures 14b all may have the same size and shape, or may have a variety of different sizes and/or shapes. First apertures 14b preferably are distributed throughout silicon sheet 40, and may have a uniform pattern, such as shown in FIGS. 5A-5C, or may have a non-uniform pattern. Persons of ordinary skill in the art will understand that silicon sheet 40 may include more or less than the number of first apertures 14b shown if FIGS. 5A-5C.

Second apertures 42 may have a circular shape, although other shapes may be used, such as rectangular, elliptical, triangular, or other suitable shape. Second apertures 42 all may have the same size and shape, or may have a variety of different sizes and/or shapes. Second apertures 42 may have a uniform pattern, such as shown in FIGS. 5A-5C, or may have a non-uniform pattern. Persons of ordinary skill in the art will understand that silicon sheet 40 may include more or less than the number of second apertures 42 shown if FIGS. 5A-5C.

Silicon sheet 40 may be rectangular, as shown in FIGS. 5A-5C, or may be circular, elliptical, triangular, or other suitable shape. In the example shown, silicon sheet 40 may have a length between about 10 cm and about 20 cm, a width between about 10 cm and about 20 cm, and a thickness between about 0.1 mm and about 1 mm. Other dimensions may be used.

First apertures 14b may have a diameter between about 20 nm and about 1000 nm, although other diameters may be used. Second apertures 42 may have a diameter between about 1 mm and about 5 mm, although other diameters may be used. First apertures 14b and second apertures 42 may be formed by patterning and etching silicon sheet 40. Other techniques may be used to form first apertures 14b and second apertures 42.

Multiple silicon sheets 40 are stacked to form a silicon anode element. For example, referring now to FIGS. 6A-6D, various example silicon anode elements 100a-100c are described. FIGS. 6A-6B illustrate silicon anode element 100a, which includes ten silicon sheets 40₁-40₁₀ stacked on top of one another without any spacers separating adjacent silicon sheets 40. Bands 44 extend through second apertures 42 and wrap around the exteriors of silicon sheets 40₁-40₁₀ to keep sheets 40₁-40₁₀ securely fixed together. Bands 44 may be string, fiber, elastic, insulated wire, or other suitable material for securing silicon sheets 40₁-40₁₀. Persons of ordinary skill in the art will understand that silicon anode element 100a may include more or less than ten silicon sheets 40.

FIG. 6C illustrates an alternative silicon anode element 100b, which includes ten silicon sheets 40₁-40₁₀ stacked on top of one another with spacers 46 separating adjacent silicon sheets 40. Spacers 46 may be between about 0.1 mm and about 10 mm, and may be fabricated from plastic, ceramic, metal, or other suitable material. Other dimensions and materials may be used. Persons of ordinary skill in the art will understand that silicon anode element 100b may include more or less than ten silicon sheets 40.

FIG. 6D illustrates another alternative silicon anode element 100c, which includes ten silicon sheets 40₁-40₁₀ stacked on top of one another with spacers 46 separating some, but not all silicon sheets 40. Persons of ordinary skill in the art will understand that silicon anode element 100c may include more or less than ten silicon sheets 40.

FIGS. 7A-7B illustrate silicon anode element 100a during charging in a lithium ion battery cell. In accordance with this invention, the volume expansion and contraction that occurs in silicon 12b during charging and discharging of silicon anode element 100a is substantially confined to first apertures 14b.

As silicon anode element 100a is charged, lithium ions penetrate silicon 12b, which causes silicon 12b to swell. However, as described in more detail below, silicon anode element 100c is substantially prevented from expanding outwardly. Instead, as lithium is inserted into silicon 12b, first apertures 14b are compressed, and the volume expansion of silicon 12b occurs substantially in the volume originally occupied by first apertures 14b, as shown in FIG. 7B. Further, as silicon anode element 100a discharges, lithium is extracted from silicon 12b, and first apertures 14b expand to their original volume, returning to the structure shown in FIG. 7A.

In accordance with this invention, multiple silicon anode elements, such as silicon anode elements 100a-100c, may be combined to form a silicon anode that is encased in a rigid container that may be used in a lithium ion battery cell. For example, referring now to FIG. 8, and example battery cell container 60 includes an anode chamber 62 that includes multiple anode element slots 64. Each anode element slot 64 is adapted to receive one silicon anode element 100a.

In particular, anode chamber 62 includes five anode element slots 64 that are adapted to receive silicon anode elements 100a₁-100a₅ that collectively form silicon anode 10b. Persons of ordinary skill in the art will understand that more or less than five silicon anode elements 100a₁-100a₅ may be used. Anode chamber 62 is made of a rigid material, such as metal, plastic, ceramic, glass, or other suitable material, that substantially prevents silicon 12b of silicon anode elements 100a₁-100a₅ from peripheral expansion during charging in a lithium ion battery cell.

In accordance with this invention, silicon anode elements 100a₁-100a₅ may variously be removed and replaced in anode element slots 64. Thus, if one or more of silicon anode elements 100a₁-100a₅ becomes defective, or a user otherwise desires to replace one or more of silicon anode elements 100a₁-100a₅, silicon anode elements 100a₁-100a₅, may be individually removed and replaced, without needing to replace all silicon anode elements 100a₁-100a₅, or the entire silicon anode 10b. Without wanting to be bound by any particular theory, it is believed that the lifespan of silicon anode 10b may be extended compared with a conventional anode.

Referring now to FIGS. 9A-9F, an example anode element container 70 for containing silicon anode elements, such as silicon anode elements 100a-100c is described. In particular, example anode element container 70 includes a first portion 72, a second portion 74, a third portion 76, and a cavity 78 extending from first portion 72 through second portion 74 and into third portion 76. A current collector 80 is disposed at the bottom of cavity 78 and extends through a slot that extends through a sidewall of third portion 76. Current collector 80 may be made from a highly conductive material, such as copper of other highly conductive material, and includes apertures 84.

A silicon anode element 100a includes ten silicon sheets 40₁-40₁₀ stacked on top of one another and secured together using strings 90. Strings 90 may be wire, nylon, glass fibers or other suitable string material. Silicon anode element 100a is disposed in cavity 78, with silicon sheet 40₁₀ mounted on current collector 80. Strings 90 extend through apertures 84 and may be secured at an underside of third portion 76 to secure silicon anode element 100a on current collector 80.

First portion 72 and second portion 74 are mounted on third portion 76, forming a closed anode element container 70 that contains silicon anode element 100a, as shown in FIG. 9B. A cover 86, such as plastic or other suitable material, seals the top surface of silicon anode element 100a.

As shown in FIGS. 9C-9D, multiple anode element containers 70₁-70₄ may be stacked together, and oriented to form a silicon anode 10c. Persons of ordinary skill in the art will understand that more or less than four anode element containers 70 may be stacked together. Anode element containers 70₁-70₄ may be fabricated to attach when adjacent anode element containers 70 are oriented in a first direction, and separate when adjacent anode element containers 70 are oriented in a second direction.

For example, first portion 72 and third portion 76 of anode element containers 70₁-70₄ may be include correlated magnets, such as those described in Fullerton et al. U.S. Pat. No. 7,681,256 (“the '256 patent”), which is incorporated by reference herein in its entirety for all purposes. Second portion 74 of anode element containers 70₁-70₄ may be made of ceramic, plastic, glass or other suitable material.

As described in the '256 patent, correlated magnets are made from a combination of magnetic (or electric) field emission sources which are configured in accordance with a pre-selected code having desirable correlation properties. Thus, when a magnetic field emission structure is brought into alignment with a complementary, or mirror image, magnetic field emission structure the various magnetic field emission sources will all align causing a peak spatial attraction force to be produced, while the misalignment of the magnetic field emission structures cause the various magnetic field emission sources to substantially cancel each other out in a manner that is a function of the particular code used to design the two magnetic field emission structures.

In contrast, when a magnetic field emission structure is brought into alignment with a duplicate magnetic field emission structure then the various magnetic field emission sources all align causing a peak spatial repelling force to be produced, while the misalignment of the magnetic field emission structures causes the various magnetic field emission sources to substantially cancel each other out in a manner that is a function of the particular code used to design the two magnetic field emission structures.

A unique characteristic associated with correlated magnets relates to the situation where the various magnetic field sources making-up two magnetic field emission structures can effectively cancel out each other when they are brought out of alignment which is described herein as a release force. This release force is a direct result of the particular correlation coding used to configure the magnetic field emission structures.

In accordance with this invention, first portion 72 and third portion 76 may include correlated magnets such that when first portion 72 of a first anode element container 70 (e.g., anode element container 70₁) is oriented 90° out of alignment with a second anode element container 70 (e.g., anode element container 70₂), such as depicted in FIG. 9C, the adjacent anode element containers 70₁ and 70₂ may be easily connected to and disconnected from one another.

In contrast, when first portion 72 of anode element container 70₁ is rotated 90° into alignment with adjacent anode element container 70₂, such as depicted in FIG. 9D, the adjacent anode element containers 70₁ and 70₂ are strongly attached to one another and may not be easily disconnected from one another. Indeed, as depicted in FIGS. 9E and 9F, by rotating anode element container 70₁ 90° out of alignment with adjacent anode element container 70₂, anode element container 70₁ may easily be separated from anode element container 70₂.

Thus, anode element containers 70₁-70₄ may variously be removed and replaced. Thus, if one or more of silicon anode elements 100a₁-100a₄ becomes defective, or a user otherwise desires to replace one or more of silicon anode elements 100a₁-100a₄, anode element containers 70₁-70₄ may be individually removed and the corresponding anode elements 100 replaced, without needing to replace all silicon anode elements 100a₁-100a₄, or the entire silicon anode 10c. Without wanting to be bound by any particular theory, it is believed that the lifespan of silicon anode 10c may be extended compared with a conventional anode.

Referring now to FIG. 10 an example lithium ion battery cell 110 in accordance with this invention is described. Example battery cell 110 includes silicon anode 10, which may be any silicon anode in accordance with this invention (e.g., silicon anode 10 of FIGS. 1A-1D, silicon anode 10a of FIG. 3, silicon anode 10b of FIG. 8, and silicon anode 10c of FIG. 9D). Battery cell 110 also has a cathode 112, and an electrolyte layer 114 between silicon anode 10 and cathode 112. In some embodiments, a first current collector 116 may be disposed adjacent silicon anode, and a second current collector 118 may be disposed adjacent cathode 112.

Cathode 112 may be a metal oxide, such as LiMnO₂, LiFePO₄, Li₂FeSiO₄, LiMnPO₄, or other suitable cathode material. Electrolyte layer 114 may be a solid and/or liquid electrolyte that includes a lithium salt in an organic solvent. First current collector 116 and second current collector 118 may be copper or some other highly conductive material.

The foregoing merely illustrates the principles of this invention, and various modifications can be made by persons of ordinary skill in the art without departing from the scope and spirit of this invention.

1. An electrode for an electrochemical lithium battery cell, the electrode comprising:
a plurality of silicon sheets, each silicon sheet comprising a plurality of apertures, each aperture extending all or partly through a thickness of the silicon sheet.

2. The electrode of claim 1, wherein the plurality of silicon sheets are stacked to form a silicon anode element.

3. The electrode of claim 2, wherein the plurality of silicon sheets are stacked without spacers between adjacent silicon sheets.

4. The electrode of claim 2, wherein the plurality of silicon sheets are stacked with spacers between one or more adjacent silicon sheets.

5. The electrode of claim 2, wherein a plurality of the anode elements are combined to form the electrode.

6. The electrode of claim 5, wherein each of the anode elements may be selectively removed from the electrode.

7. The electrode of claim 1, wherein each of the silicon sheets has a length between about 10 cm and about 20 cm, a width between about 10 cm and about 20 cm, and a thickness between about 0.1 mm and about 1 mm.

8. The electrode of claim 1, wherein the apertures comprise a plurality of different dimensions.

9. The electrode of claim 1, wherein the apertures are distributed uniformly or non-uniformly throughout each of the silicon sheets.

10. The electrode of claim 1, wherein the apertures each have a diameter between about 20 nm and about 1000 nm.

11. A method of providing an electrode for an electrochemical lithium battery cell, the method comprising:
providing a plurality of silicon sheets; and
forming a plurality of apertures in the silicon sheets, each aperture extending all or partly through a thickness of the silicon sheet.

12. The method of claim 11, further comprising stacking the plurality of silicon sheets to form a silicon anode element.

13. The method of claim 12, further comprising stacking the plurality of silicon sheets without spacers between adjacent silicon sheets.

14. The method of claim 12, further comprising stacking the plurality of silicon sheets with spacers between one or more adjacent silicon sheets.

15. The method of claim 12, further comprising combining a plurality of the anode elements to form the electrode.

16. The method of claim 15, wherein each of the anode elements may be selectively removed from the electrode.

17. The method of claim 11, wherein each of the silicon sheets has a length between about 10 cm and about 20 cm, a width between about 10 cm and about 20 cm, and a thickness between about 0.1 mm and about 1 mm.

18. The method of claim 11, wherein the apertures comprise a plurality of different dimensions.

19. The method of claim 11, wherein the apertures are distributed uniformly or non-uniformly throughout each of the silicon sheets.

20. The method of claim 11, wherein the apertures each have a diameter between about 20 nm and about 1000 nm.
